(19) United States
(12) Patent Application Publication
(10) Pub. No.: US 2013/0170097 A1
(43) Pub. Date: Jul. 4, 2013

(54) YTTRIA-STABILIZED ZIRCONIA BASED CAPACITOR

(71) Applicants: Daniel C. Sweeney, Burbank, CA (US); John B. Read, San Diego, CA (US)

(72) Inventors: Daniel C. Sweeney, Burbank, CA (US); John B. Read, San Diego, CA (US)

(73) Assignee: Space Charge, LLC, Aspen, CO (US)

(21) Appl. No.: 13/536,029

(22) Filed: Jun. 28, 2012

Related U.S. Application Data
(60) Provisional application No. 61/502,797, filed on Jun. 29, 2011.

(51) Int. Cl. H01G 9/00

(52) U.S. Cl. CPC H01G 9/155
USPC 361/502

(57) ABSTRACT

Devices and methods for storing energy at a high density are described. In some embodiments, the devices include a first electrode and a second electrode containing a transition metal oxide. A solid electrolyte having yttria-stabilized zirconia (YSZ) is located between the first and second electrode. The thickness of the electrolyte located between the two electrodes is less than one micrometer.

### CROSS-REFERENCES TO RELATED APPLICATIONS

This application claims benefit under 35 U.S.C. §119(e) of U.S. Provisional Patent Application No. 61/502,797, filed on Jun. 29, 2011, which is hereby incorporated by reference in its entirety for all purposes.

### BACKGROUND

Capacitive interaction occurs in all electronic circuits. Accordingly, discrete capacitors are included in the circuits to fulfill a variety of roles including frequency filtration, impedance matching and the production of electrical pulses and repetitive signals. Regardless of the complexity of the design, a capacitor can be thought of as two closely spaced conducting plates which may have equal and opposite charges (±Q) residing on them when a voltage (V) is applied. The scalar quantity called capacitance (C) is the ratio of the charge to the applied voltage. When capacitance increases, a significant charge can be stored and the device can be used like a battery.

Though common batteries have a high energy density, they can only deliver a relatively small current since the current must be generated by a chemical reaction occurring within each storage cell. By contrast, capacitors may have a low energy density but can discharge very quickly—a flexibility which is desirable for many applications. Superconducting magnetic energy storage (SMES) is an alternative, but still suffers from a low storage density combined with impractical mass and thermal complexities.

The stored charge can be further increased by using an electric double-layer capacitor (EDLC) design. EDLC's have higher energy density than traditional capacitors and are sometimes referred to as “supercapacitors”. Energy density can be defined as the amount of charge stored per unit volume. However, the storage density of EDLC's can still be improved upon, and despite some technological advances, further increases in energy storage density of capacitors may improve upon traditional batteries.

### BRIEF SUMMARY

Devices for storing energy at a high density are described. In some embodiments, the devices include a first electrode and a second electrode containing a transition metal oxide. A solid electrolyte having yttria-stabilized zirconia (YSZ) is located between the first and second electrode. The thickness of the electrolyte located between the two electrodes is less than one micrometer.

Additional embodiments and features are set forth in part in the description that follows, and in part will become apparent to those skilled in the art upon examination of the specification or may be learned by the practice of the disclosed embodiments. The features and advantages of the disclosed embodiments may be realized and attained by means of the instrumentalities, combinations, and methods described in the specification.

### BRIEF DESCRIPTION OF THE DRAWINGS

A further understanding of the nature and advantages of the disclosed embodiments may be realized by reference to the specification and the drawings.

FIG. 1 shows a block diagram of a solid-state capacitor according to disclosed embodiments.

FIG. 2 shows another block diagram of a solid-state capacitor according to disclosed embodiments.

FIG. 3 shows a cross-sectional view of a solid-state storage capacitor stack according to embodiments of the present technology.

FIGS. 4A-4B show cross-sectional views of additional solid-state storage capacitor stacks according to embodiments of the present technology.

FIG. 5 is a flowchart for a method of making a solid-state storage capacitor according to disclosed embodiments.

FIG. 6 is a flowchart for another method of making a solid-state storage capacitor according to disclosed embodiments.

In the appended figures, similar components and/or features may have the same reference label. Further, various components of the same type may be distinguished by following the reference label with a letter. If only the reference label is used in the specification, the description is applicable to any one of the similar components having the same reference label irrespective of the additional letter label.

### DETAILED DESCRIPTION

The ensuing description provides some preferred embodiments only, and is not intended to limit the scope, applicability, or configuration of the disclosure. Rather, the ensuing description of embodiments will provide those skilled in the art with an enabling description for implementing an embodiment of the disclosure. It should be understood that various changes may be made in the function and arrangement of elements without departing from the spirit and scope of the technology as set forth in the appended claims.

Devices for storing energy at a high density are described. In some embodiments, the devices include a first electrode and a second electrode containing a transition metal oxide. A solid electrolyte having yttria-stabilized zirconia (YSZ) is located between the first and second electrode. The thickness of the electrolyte located between the two electrodes is less than one micrometer.

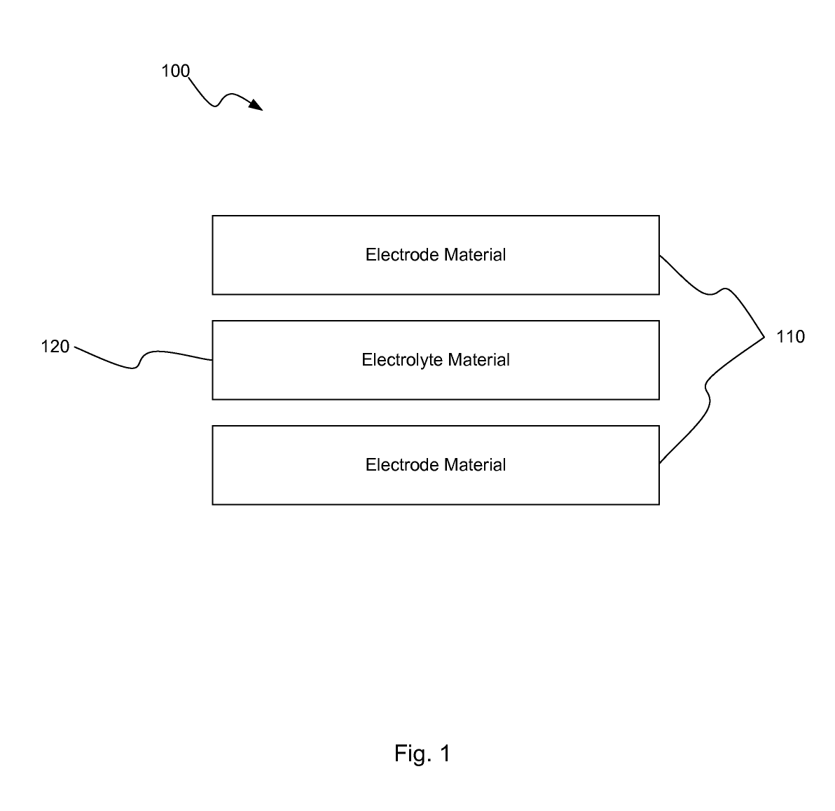

Referring first to FIG. 1, a block diagram is shown describing a capacitor structure 100 according to disclosed embodiments. The capacitor structure includes a layer of dielectric material 120 disposed between two electrodes 110. The electrodes 110 may include conductive materials, and may include a transition metal. The transition metal may be a transition metal oxide, and may include any transition metal oxide that may support redox behavior. The dielectric material 120 may include YSZ and may be used as the substrate on which the electrode material is formed. The formed capacitor structure may be used as a flat capacitor, or may be rolled into a spiral geometry.

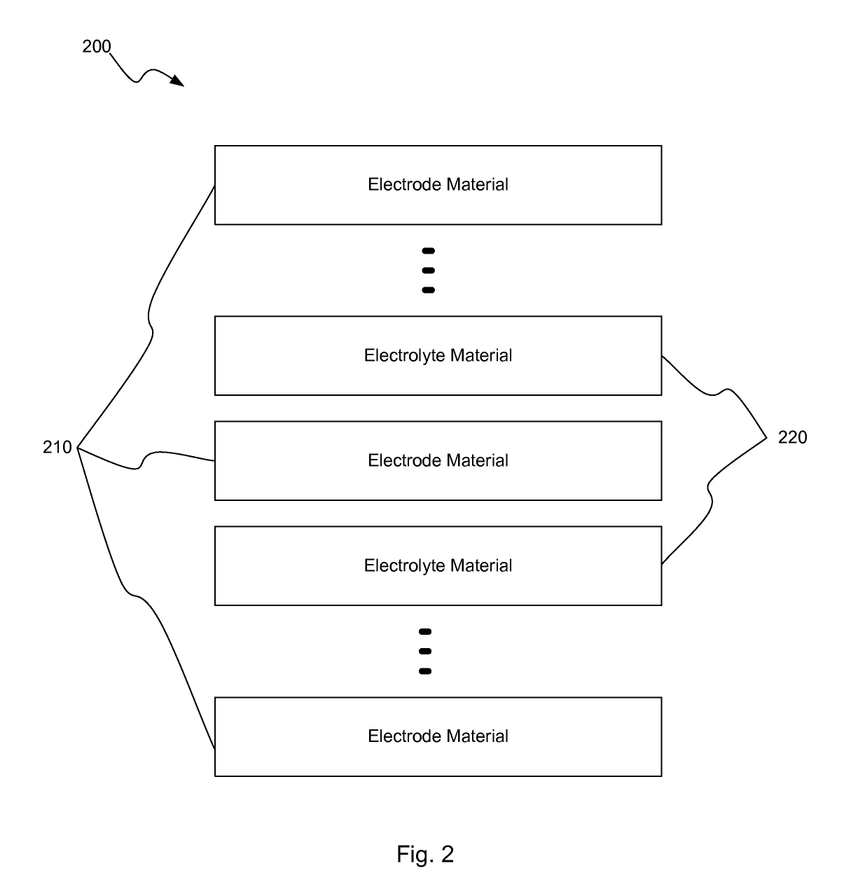

Referring to FIG. 2, a block diagram is shown describing a layered capacitor stack 200 according to described embodiments. The capacitor stack includes layers of dielectric material 220 alternating between layers of electrode material 210. In some embodiments, the electrode material is a transition metal oxide. In embodiments the transition metal oxide is ruthenium oxide, manganese oxide, or other oxides that can have their oxidation number changed, and thus support redox behavior. In embodiments the transition metal oxide is ruthenium oxide that is in one of a variety of oxidation states of the compound. The ruthenium used can be in an oxidation state of from 0 to +8, and in various embodiments is ruthenium(II), (III), (IV), (V), (VI), or (VIII). In other embodiments, the electrodes 210 are all ruthenium in the same oxidation state. In still other embodiments, the electrodes 210 are all different oxidation states, or are alternating oxidation states. It will appreciated that many combinations are available that are all envisioned by the technology.

The number of layers in the stack can be based on any number of factors including the specific thickness required for the device, or based on a required amount of storage density. For example, in some embodiments the solid-state capacitor may include two electrodes disposed on opposite sides of a dielectric material. Alternatively, the capacitor may include 3 electrodes or more, where a first dielectric material is disposed between the first and the second electrode, and a second dielectric material is disposed between the second and the third electrode. The dielectric material may be a solid electrolyte, and the layers may be formed in a number of ways as will be described in further detail below.

In alternative exemplary devices more than three electrodes may be used, and in some embodiments the capacitor includes at least about 3, 4, 5, 6, 7, 8, 9, 10, 15, 20, 50, etc., or more layers of electrodes. A dielectric material, including a solid electrolyte may be disposed between every two layers of electrode material, such that, for example, if the number of electrode layers used is X, then the number of electrolyte layers used is X−1, which accounts for the two electrodes that begin and end the capacitor structure. Alternatively, fewer layers of electrolyte may be used, or a greater number of electrolyte layers may be used and the layers of material may be stacked upon each other to provide additional thicknesses. For example, the process for forming the solid electrolyte may produce a sheet of electrolyte that is divided into the required dimensions. If thicker layers of dielectric material are required in certain layers of the capacitor, these layers of dielectric material may be stacked, and thus more layers of dielectric material may be used than layers of electrode material. Depending on the thickness of the layers, the solid-state capacitor may be maintained at a thickness of less than or about 1 micrometer. Accordingly, if the thickness of each individual layer is reduced, the overall thickness of the capacitor may be maintained at less than or about 1 micrometer regardless of the number of layers of electrode and electrolyte material.

In exemplary capacitor designs, the layers of electrode and dielectric material may be equal to one another such that every layer of the capacitor structure is of a substantially uniform thickness. Alternatively, the electrodes may be of a substantially uniform thickness as compared to one another, and the layers of dielectric material may be of a substantially uniform thickness as compared to one another. The thickness of the dielectric material may be similar to, less than, or greater than the thickness of the electrode material. In some embodiments the thickness of the dielectric material may be several times greater than the thickness of the electrode material. For example, the dielectric material may be at least or about twice the thickness of the electrode layers. In alternative capacitors, the dielectric material is at least or about 3, 4, 5, 6, 7, 8, 9, 10, etc. or more times the thickness of the electrode material.

In some embodiments, the electrolyte material having YSZ can have greater than or about five percent yttria content in the ceramic. In other embodiments the yttria content is at least about eight percent, ten percent, fifteen percent, twenty percent, or more. Because of the oxygen vacancies created with the substitution of zirconium, a higher content of yttria in the structure can allow for the electrolyte to conduct oxygen ions. Hence, yttria contents over five percent may be used in embodiments. The YSZ electrolyte is a completely solid-state electrolyte in some embodiments, and in other embodiments includes a level of hydration to induce the ruthenium oxide to have improved performance as an oxidative catalyst. YSZ is an electrolyte in embodiments due to its high dielectric strength and its ability to conduct ion migration between electrodes. However, in other embodiments other materials are used as the electrolyte, and can include polymers that have structures including poly(ethylene oxide), poly(vinylidene fluoride), polymethyl-methacrylate, polyacrylonitrile, poly-propylene, poly-propylene oxide, plastics, ionic liquid gel polymer electrolytes, ceramics, ionic liquids, or other polymers or combinations of polymers that can allow for ion mobility. Additionally, in other embodiments, the structures are based on the polymers listed above, but have been augmented, synthesized, or reformulated to provide improved ion mobility or other physical characteristics to enable better conformity or use as an electrolyte.

The capacitor including the transition metal oxide electrodes and the YSZ electrolyte can provide capacitance that includes both electrostatic capacitance in the YSZ electrolyte layer, as well as Faradaic or pseudocapacitance at the ruthenium oxide interface. By having a transition metal such as ruthenium as the electrode, the overall realized capacitance achieved can be much higher than the capacitance realized from electrostatic capacitance alone. For example, the space charge in the capacitor through the YSZ can be above about 5 Joules per square centimeter, above about 10 J/cc, above about 15 J/cc, above about 20 J/cc, or higher in various embodiments. However, the overall energy density of the capacitor that contains the first and second electrodes of a transition metal oxide and the YSZ electrolyte can have an overall energy density that is many times greater than the electrostatic charge density due to the pseudocapacitance at the ruthenium oxide interface. This charge-transfer process can provide a Faradaic multiplier to the energy density of the capacitor which can be greater than or about 10, greater than or about 30, greater than or about 50, greater than or about 100, or greater than or about 1000 in various embodiments. Thus, for example, if the electrostatic charge of the capacitor in one embodiment is 15 J/cc, the overall energy density of the capacitor with the Faradaic multiplier can be 750 J/cc or more.

The total realized capacitance of the capacitor is a function of several variables including the thickness of the electrolyte layer. The electrolyte YSZ layers 220 are less than or about one micrometer in thickness, and in different embodiments are less than or about 500 nanometers, less than or about 100 nanometers, less than or about 50 nanometers, or less than or about 20 nanometers in total thickness. The Inventors have surprisingly found that the thinner the electrolyte layer, the greater the ionic migration afforded by the YSZ. When the thickness of the electrolyte is reduced below one micrometer and less, the ionic migration can be increased by several orders of magnitude, which can increase the overall energy density of the capacitor incredibly.

The capacitors can be stacked in layers in some embodiments, and in alternative embodiments, the alternating layers of electrode and dielectric are continued until an overall stack structure is formed. The electrode stack can include multiple capacitor layers, and in some embodiments can have tens of layers. In other embodiments, the stack can have hundreds of layers, thousands of layers, or tens of thousands of layers for different applications. The thickness of the overall stack will increase with an increased number of layers of capacitors, but is also a function of the thickness of the alternating layers. Alternatively, the formed stack may be rolled to produce a spiral geometry capacitor.

As an example, and not with the intention to limit the scope of the technology, the thickness of the electrolyte YSZ layer 220 may be less than or about 100 nanometers. The first and second electrodes 210 may be less than or about 80 nanometers, and thus the thickness of a capacitor with these elements would be less than 260 nanometers. In other embodiments, the electrodes 210 are less than or about 50 nanometers, less than or about 20 nanometers, less than or about 15 nanometers, or less than or about 10 nanometers. As another example, the electrolyte YSZ layer may be less than or about 50 nanometers, and the first and second electrodes are less than or about 15 nanometers each. Accordingly, the capacitor with these elements would be less than 80 nanometers thick.

Based on this exemplary structure, a capacitor stack that is one millimeter in total thickness, can include over twelve thousand five hundred capacitors of the dimensions described above. In other embodiments, the capacitor stack can include over fifteen thousand capacitors, over twenty thousand capacitors, over fifty thousand capacitors, over one-hundred-thousand capacitors, over five-hundred-thousand capacitors, or over one-million individual capacitor layers. The total number of capacitors in embodiments is a function of the thickness of the capacitor stack, and thus can be virtually infinite based on stacks of greater thicknesses. Exemplary capacitors may be made of any geometry, and as described previously, the layers may be formed at a minimum thickness or length, but may alternatively be made of an extended thickness or length that can be more than or about one millimeter, one centimeter, up to and including one meter or more, and the resulting structure may be rolled into a spiral capacitor. Overall, the techniques described may be used to produce capacitors from several nanometers in external dimensions up to several meters in external dimensions.

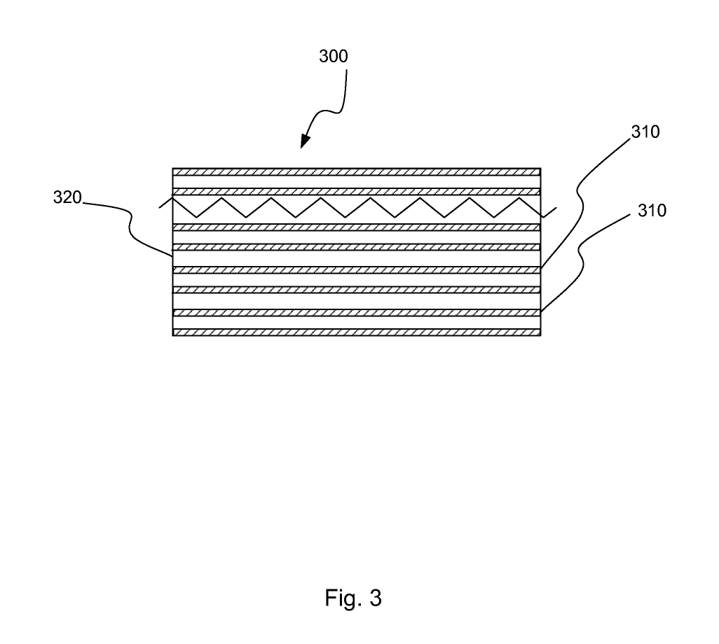

FIG. 3 shows a solid-state storage capacitor stack 300 according to embodiments of the present technology. The stack includes alternating layers of electrodes 310 and electrolyte material 320. In some embodiments, the stack is approximately one centimeter by one centimeter, by one millimeter thick. These dimensions may provide over 15,000 capacitors contained in one stack. The capacitor stacks can themselves be combined in various packs such that multiple stacks, of multiple capacitors can be contained together. Therefore, in one embodiment, a one square meter area for storage, can contain 10,000 stacks, which thus contains over 150,000,000 capacitors in the storage area. These stacks can be connected in parallel, series, or interconnected in any way that allows the use of the capacitor stacks.

In some embodiments, when charging capacitor 300, heat is applied to the stack in order to activate the YSZ electrolyte. Heating the YSZ facilitates ion migration within each capacitor. The heat is applied to the stack continuously or intermittently to keep the temperature above a threshold while charging. In various embodiments, the temperature to which the stack is heated is above 50° C., above 100° C., above 200° C., above 300° C., above 400° C., above 500° C., above 600° C., or more. In other embodiments, the temperature of the stack is maintained below a temperature suitable for YSZ due to the electrodes contained within the stack. Ruthenium oxide, for example, can begin to partially breakdown above 600° C., and thus in some embodiments, the temperature of the stack is maintained below such temperature during charging.

Heating the stack during charging can be accomplished in any number of ways. In some embodiments, the capacitor stacks are maintained in an insulated enclosure, and thus the heating can be performed by a heater within or connected with the enclosure. In other embodiments, integrated circuitry is provided between the stacks that is capable of heating the individual stacks above a temperature needed for YSZ activation. Alternatively, eddy currents in the metallic electrodes may be induced and used as heating elements within the stack or capacitor. In still other embodiments, waste application heat is used to heat the stacks to the required temperature. For example, in one embodiment the capacitor stacks can be used in an automobile that utilizes regenerative breaking. When the breaking is applied, heat is produced that can be transferred to the capacitor stacks to raise the temperature to the required activation temperature for the YSZ. Many other waste heat, direct heat, or indirect heating sources can also be used in various embodiments. In addition to being able to activate the YSZ, the inventors have also found that higher temperatures may also provide more ionic mobility. Accordingly, the temperature at which the capacitors may be operated can be balanced to benefit structural integrity while also utilizing enhanced ionic mobility.

As shown in the illustration, a flat configuration has been used. However, various other embodiments may include a corrugated or otherwise textured surface between layers of material in order to further increase the available surface area within the dimensions of the structure. Individual layers, such as the electrolyte may also be machine textured in order to produce a pattern that increases the surface area as compared to an otherwise flat surface. The procedure used for the texturing may include holographic lithography, photoresist and etch, or other methods that may remove material from the surface. For example, the electrolyte material may be textured to increase the surface area at least twice as much as a comparable flat surface of similar dimensions. Still other processes may texture the surface to increase the area by at least or about 3, 4, 5, 10, 20, 50, 100 times or more as compared to a flat surface of similar outer dimensions. The texturing may additionally be performed with an additive process in which nano-scale particles are formed over the surface of the electrolyte or electrode. The particles may be sputtered or otherwise deposited or grown on the surface of the material to increase the overall surface area. The particles may be inert or conductive, and may include metal or other material as described throughout this disclosure.

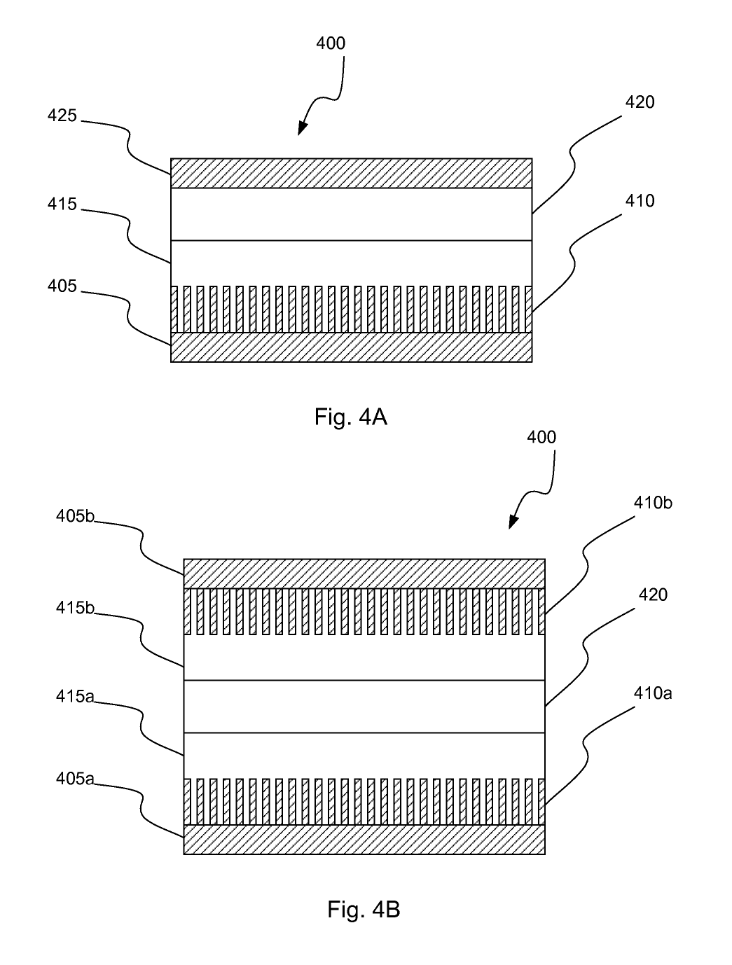

FIGS. 4A and 4B show cross-sectional views of additional exemplary solid state capacitors according to the present technology. Referring to FIG. 4A, a solid state capacitor 400 including a nanotube substrate is shown. The substrate 405 may be made of a conductive material and may comprise a portion of the electrode structure. In some embodiments the substrate is made of a carbon based material, but may alternatively be a metal or other conductive material. The substrate may have extensions 410 such as nano-extensions formed or disposed on a surface. The extensions may be, for example, nanotubes, but a variety of nano-structures may be used. Although shown equally spaced across the substrate, it can be recognized that the nanotubes may be formed throughout the surface of the substrate, and may form a carpet-like structure across the surface. An additional material 415 may be disposed over and/or within the extensions 410, and may comprise an additional portion of the electrode structure. In some embodiments, the material 415 includes a transition metal or transition metal oxide.

Overlying the material 415 may be a dielectric material 420. The dielectric material 420 may include a solid electrolyte or additional material. In embodiments, the dielectric material 420 includes a transition metal, and may for example include yttria-stabilized zirconia. Additional dielectric materials may include polymer based dielectrics, and may be chosen to withstand and/or support electrical potentials above about 5 volts or more while still supporting ionic migration. An additional electrode 425 may be disposed over the dielectric material 420 to complete the capacitor structure. The second electrode 425 may be the same or a different material as any of the first electrode layers 405, 410, and 415. The capacitor may additionally include more layers of material to produce a stack capacitor having a plurality of electrodes and at least one or more layers of dielectric material. Utilizing electrode structures that include nanotubes may increase the available surface area of the electrode, and may provide a greater amount of the electrode structure that can participate in charge storage and redox reactions. This may in turn increase the available amount of capacitance over alternative structures.

As shown in FIG. 4B, the capacitor structure 400 may alternatively include two or more electrodes that have extensions such as nanotubes. Similar to the structure described in FIG. 4A, the substrate 405a may include extensions 410a, such as nano-extensions, on which an additional material 415a is disposed. A dielectric layer 420 may be deposited over the electrode structure. A second electrode structure similar to the first may be formed over the dielectric material 420. Depending on the production process, the material 415b may first be disposed over the dielectric material 415 prior to the nano-extensions 410b and substrate 405b. Alternatively, the substrate 405b may be provided with nano-extensions 410b. The material 415b may be deposited in and/or around the extensions 410b, after which the second electrode structure may be coupled with the dielectric material 420. In alternative structures, the first electrode structure is different from the second electrode structure in that at least one material used in the first structure is different from at least one material used in the second structure. Several varieties for forming such a capacitor will be additionally described below.

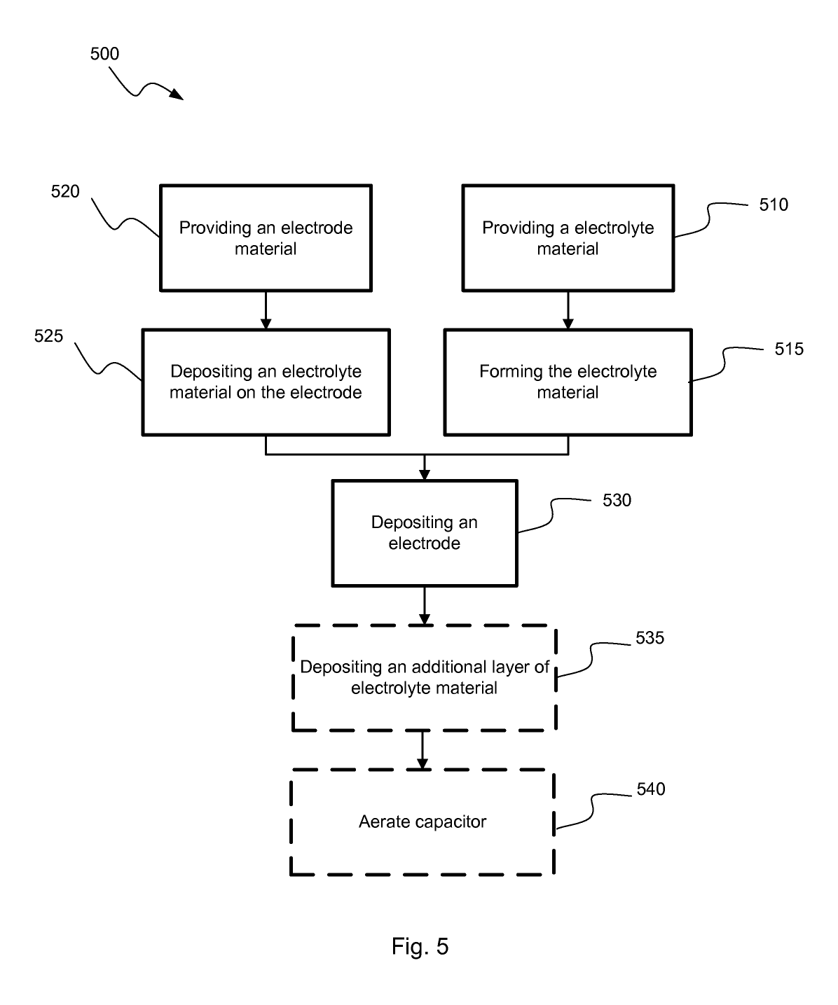

FIG. 5 is a flowchart for making a solid-state storage capacitor according to disclosed embodiments. The method 500 can include providing either an electrolyte material 510 or an electrode material 520. If an electrolyte material 510 is provided, that electrolyte is formed 515 into a layer to be used in the capacitor. Hence, the electrolyte is conformally formed to the necessary thickness for the capacitor. After the electrolyte has been formed to the proper dimensioning for the capacitor, an electrode is deposited 530 thereon, and can be deposited on each side of the electrolyte material in other embodiments. For a stack of capacitors, an electrolyte with deposited electrodes can also have additional layers deposited 535 thereon. These layers can include one or more electrolyte layers, and can also include alternating electrolyte and electrode layers. Alternatively, a first electrolyte material may be provided on which a first electrode is deposited. A second electrolyte material may also be provided on which a first electrode is deposited on a first side of the electrolyte, and a second electrode is deposited on a second side of the electrolyte. The first electrode having a side opposite the side on which the first electrode was deposited may be coupled with the second electrolyte on either the first or second side. The resulting structure may include three electrodes with alternating layers of electrolyte material. Either process may be repeated in various ways to produce a capacitor stack that includes a plurality of electrodes and electrolyte layers as discussed previously.

In an alternative embodiment an electrode material is provided 520. An electrolyte material is deposited on the electrode 525, and then another electrode can be deposited on the electrolyte layer 530. Thereafter, additional layers of electrolyte and electrode material can optionally be sequentially deposited 535 to create a stacked capacitor. In some embodiments the electrode is produced in a film, while in alternative embodiments, depending on the electrode material, the electrode is a foil or foam of metal or other material that is used for the deposition of the electrolyte material. Again, the layers may be repeated in any of the previously discussed ways in order to produce a capacitor stack that includes multiple layers of electrodes and electrolyte materials.

Additionally, the capacitor or optionally the stack of capacitor layers may be aerated at step 540. Aeration of the capacitor structure may provide airflow pathways through the structure, which can be utilized to provide oxygen for the capacitor. In this way, oxygen that may be delivered to or through the capacitor structure may be extracted or incorporated into the capacitor and allowed to diffuse through the layer of electrolyte. Thus, ionic migration may be facilitated and a supply of fuel in the form of continuously or periodically delivered oxygen may be used to support the reaction.

The aeration may take the form of pores defined in the structure of the capacitor, and may be produced by any number of means. In one embodiment, a photo resist pattern may be deposited that defines regions through which etching may be performed through the capacitor structure to produce through-holes or channels. Alternatively, other methods of etching, ablating, or nano-scale drilling or boring may be used to produce the channels that may include wet and dry chemical methods, ion based methods, as well as laser based methods, among others. The aeration channels may be defined to a dimension that may range from a few nanometers in width to several centimeters in width, depending on the overall dimensions of the capacitor. For example, channels may be formed through the stack that are about 10 nm or less in width and traverse the entire height of the capacitor structure. Alternatively, the channels may have a width of less than, at least, or about 20 nm, 40 nm, 50 nm, 75 nm, 100 nm, 500 nm, 10 μm, 50 μm, 100 μm, 500 μm, 1 mm, 1 cm, 10 cm, etc. or more. The channels may traverse the height of the stack along a vertical axis, or the channels may traverse the stack non-axially, and may be formed at varying angles to a central axis along the entire surface, or a portion of the surface. Alternatively, two or more, up to all, of the channels may be formed at a similar angle to one another across the capacitor structure.

In operation, air may be passed along or through the capacitor or stack in order to provide oxygen to the structure. The air may be directed toward the channels, or may be flowed along the channels in different embodiments. An air delivery or circulation system may be utilized to provide the air or oxygen to the device. For example, if the capacitor, capacitors, or stacks are housed in an enclosure, an air flow system may be incorporated into the enclosure. For example, the air flow system may include a means for providing air to the channels. The means may include fans, electromagnetic devices or diaphragms, electrostatic or electrostatically driven devices, etc., or may provide a channel for air delivery based on convective flow of air across the heated capacitor structure. When passed over and/or through the structure, oxygen may be utilized by the capacitor as previously described. Any type of ambient air, oxygen-enriched, or otherwise processed gas may be used with this system.

In yet another embodiment, an ionization system may be utilized to provide oxygen alone to the aerated capacitor. Alternatively, an oxygen tank may be used in some examples, but this oxygen tank may need to be replenished over time. Some air flows, or contaminants in the air, may reduce the efficiency or otherwise corrupt some capacitor systems. An ionization system coupled with the airflow system or otherwise coupled with the capacitor device may allow various fluids to be used that may have oxygen removed, stripped, or separated for use, and may remove unwanted species or prevent their flowing to or toward the capacitor structure. For example, an ionization system coupled upstream or downstream from the air delivery system may be provided air or otherwise draw in fluid with an internal air delivery mechanism. The ionization system may remove oxygen in forms including O₂, O₃, or radicalized oxygen for use by the capacitor. The oxygen may be allowed to flow or be otherwise directed toward the capacitor structure for use. In other embodiments, atoms and molecules other than those containing oxygen may be utilized.

The electrolyte material can be formed for the capacitor by various means. In one embodiment, layers of YSZ or other electrolyte are epitaxially grown under a vacuum. Molecular beam epitaxy can provide a film of electrolyte that is less than one micrometer in a relatively short period of time. Alternatively, in other embodiments atomic layer deposition or epitaxy is utilized to produce a conformal film of electrolyte at a thickness of less than one micrometer. In still other embodiments, the YSZ is sputter deposited to form layers less than one micrometer in thickness. In yet other embodiments, chemical vapor deposition, pulsed layer deposition, and magnetron sputtering can be used to deposit the layer.

The electrodes may be deposited on the electrolyte by one of the same or alternative methods as described above. In one embodiment, ruthenium oxide is sputter deposited on the YSZ electrolyte to a thickness that is less than or about 15 nanometers. In alternative structures, the thickness may be less than or about 20 nm, 50 nm, or more. In some embodiments, multiple layers of YSZ electrolyte are deposited that exhibit different porosity, hardness, or hydration. In some embodiments, an outer layer of YSZ is less hard or more porous than an interior layer that can be fully dense. These layers can be of the same or differing thicknesses.

In some embodiments the outer layer is only a few molecules in thickness in order to support electrode particles. Thus, when the ruthenium oxide electrode is deposited onto the electrolyte, some particles will become embedded within the electrolyte structure. As more of the electrode is deposited, the embedded particles will form a surface on which later particles can attach, and a layer of electrode can thus be formed. In some embodiments, the same deposition method is used to deposit alternating layers of electrode and electrolyte to form the stacked capacitor structure.

When some electrode particles become embedded into the electrolyte, an electrode structure is created where charge concentration occurs at the narrow tips of tributaries created by the embedded electrode particles, which may be ruthenium oxide in some embodiments. In other embodiments, some of the embedded particles of electrode are not connected to the full electrode structure, and islands are created that are not in direct contact with the conductive substrate, which causes electric dipoles to form. Advantageously, the formation of these dipoles increases the permittivity of the capacitor—in some embodiments it increases the permittivity greatly—and at the same time such a structure will still supertonic migration.

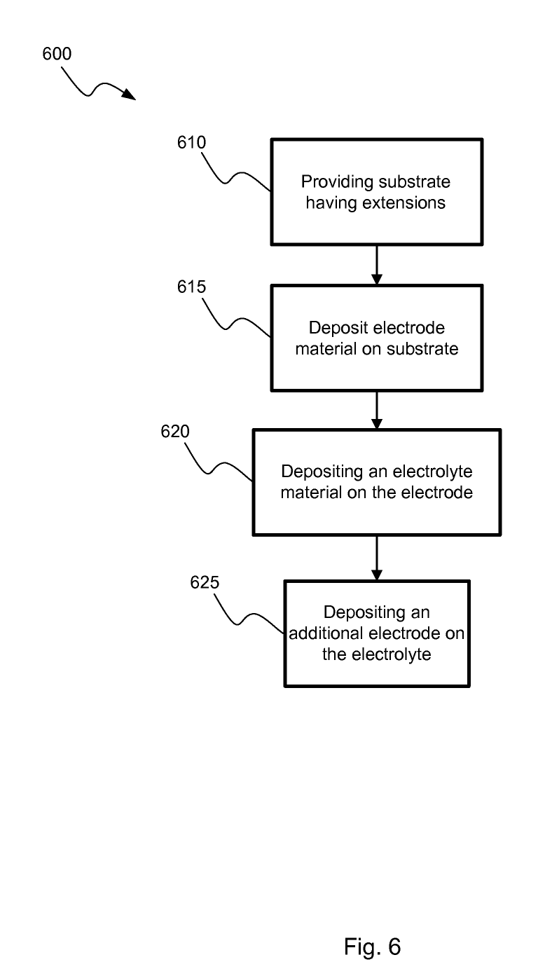

Turning to FIG. 6, another method 600 of forming a capacitor according to embodiments according to the present technology is shown. In step 610 a substrate may be provided or produced that includes nanotubes, or nano-extensions disposed thereon. The extensions may cover a portion of the substrate, and may cover at least about 50% or more of the area of the substrate. In alternative embodiments, the extensions may cover more than or less than about 50% of the area of the substrate. For example, the extensions may cover at least about 60%, 70%, 80%, 90%, 95%, 99%, etc. or more of the area of the substrate.

An additional electrode material may be deposited over the extensions at step 615. The material may be flowable due to heating, mixture with volatiles, or other ways that may allow the material to fill in the area between the extensions. For example, metal or other conductive material may be incorporated into a flowable substance that is used to coat the extensions. Alternatively, the extensions are hollow and may be filled with the additional material at step 615. A combination of filling the extensions and surrounding the extensions may also be utilized to increase the surface area of charge-storing material. In various embodiments, the extensions and the additional material may be the same or different materials from one another. For example, the extensions may include carbon or boron, while the additional electrode material may include transition metals or transition metal oxides.

At step 620 an electrolyte material may be deposited on the formed electrode structure. The electrolyte may be flowable or alternatively may be a solid electrolyte that is coupled with the electrode structure. The structures may be coupled with heating, pressure, or some combination of the two to ensure a sufficient contact area between the structures. Alternatively, an additional material may be disposed between the two layers to ensure no gaps are formed between the contact layers. The electrolyte may include various materials, and may include transition metals in the electrolytic. For example, yttria-stabilized zirconia as previously described may be used as the electrolyte. Alternatively, a polymer having previously discussed characteristics may be used instead.

After the electrolyte material has been formed over the first electrode, a second or additional electrode may be deposited or otherwise formed over the electrolyte at step 625 to complete a capacitor structure. The additional electrode may include extensions similar to the first substrate or may include a layer of electrode material. Additional layers or capacitor structures may be stacked over the produced structure in order to form a capacitor stack.

In alternative methods, after the electrolyte has been formed, a carpet of nanotubes is deposited to serve as a structure for the deposition of the electrode. The nanotubes may be inserted into the electrolyte or into material deposited over the electrolyte to ensure adequate coverage. For example, the electrode material that may include a transition metal or transition metal oxide may be deposited over the electrolyte. The nanotubes may then be fitted into the material to produce a final electrode structure. Any element capable of being formed into nanotubes can be used in various embodiments, and can include carbon and boron, among others. In one embodiment boron nanotubes are formed at the outer boundary of the YSZ. The nanotubes facilitate the deposition of electrode materials such as ruthenium oxide on the electrolyte material.

In some embodiments, boron is used in the nanotubes due to the heating of the capacitor during charging to promote ion migration. In embodiments in which the temperature of the capacitor is heated above a threshold temperature, carbon nanotubes may ignite during the ion migration. The boron nanotubes may be filled, surrounded, or both with the ruthenium oxide to create a pillar-like structure for the electrode. Such a structure still allows for conventional charge storage, and additionally can still support redox reactions at the surface interface.

Having disclosed several embodiments, it will be recognized by those of skill in the art that various modifications, alternative constructions, and equivalents may be used without departing from the spirit of the disclosed embodiments. Additionally, a number of well-known processes and elements have not been described in order to avoid unnecessarily obscuring the present technology. While the principles of the disclosure have been described above in connection with specific apparatuses and methods, it is to be clearly understood that this description is made only by way of example and not as limitation on the scope of the disclosure.

As used herein and in the appended claims, the singular forms “a”, “an”, and “the” include plural referents unless the context clearly dictates otherwise. Thus, for example, reference to “a process” includes a plurality of such processes and reference to “the electrolyte material” includes reference to one or more electrolyte materials and equivalents thereof known to those skilled in the art, and so forth.

Where a range of values is provided, it is understood that each intervening value, to the smallest fraction of the unit of the lower limit, unless the context clearly dictates otherwise, between the upper and lower limits of that range is also specifically disclosed. Each smaller range between any stated value or intervening value in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A solid-state capacitor, comprising:
a first electrode and a second electrode containing a transition metal oxide;
a solid electrolyte having yttria-stabilized zirconia that is located between the first and second electrodes, wherein the solid electrolyte is less than one micrometer thick.

2. The solid-state capacitor of claim 1, wherein the combined thickness of the first electrode, the solid electrolyte, and the second electrode is less than or about one micrometer.

3. The solid-state capacitor of claim 2, wherein the combined thickness of the first electrode, the solid electrolyte, and the second electrode is less than or about 100 nanometers.

4. The solid-state capacitor of claim 1, wherein the yttria content of the solid electrolyte is at least 8%.

5. The solid-state capacitor of claim 1, wherein the yttria content of the solid electrolyte is about 10%.

6. The solid state capacitor of claim 1, wherein the capacitor has a measurable capacitance based on a combination of electrostatic and faradaic capacitance.

7. The solid-state capacitor of claim 1, wherein the first electrode further comprises boron.

8. The solid state capacitor of claim 7, wherein the first electrode comprises boron nanotubes on which the transition metal oxide is deposited.

9. The solid state capacitor of claim 8, wherein the transition metal oxide is deposited in between the boron nanotubes such that the electrode comprises extensions of the transition metal oxide around the boron nanotubes.

10. The solid state capacitor of claim 9, wherein the second electrode comprises boron nanotubes on which the transition metal oxide is deposited.

11. The solid-state capacitor of claim 1, wherein the transition metal oxide is ruthenium oxide or manganese oxide.

12. An energy storage device, comprising a capacitor having:
a plurality of electrodes each including a transition metal oxide;
at least one solid electrolyte disposed between at least two of the plurality of electrodes, the solid electrolyte having yttria-stabilized zirconia that is located between the first and second electrodes, wherein the solid electrolyte is less than one micrometer thick.

13. The solid state capacitor of claim 12, wherein the capacitor includes at least three electrodes, and at least two solid electrolytes, and wherein a first layer of solid electrolyte is disposed between the first and the second electrode, and a second layer of solid electrolyte is disposed between the second and the third electrode.

14. The solid-state capacitor of claim 13, wherein the combined thickness of the at least three electrodes and the at least two solid electrolytes is less than or about one micrometer.

15. The solid state capacitor of claim 13, wherein the capacitor includes at least five electrodes, and at least three solid electrolytes, and wherein a first layer of solid electrolyte is disposed between the first and the second electrode, and a second layer of solid electrolyte is disposed between the second and the third electrode.

16. The solid-state capacitor of claim 15, wherein the capacitor includes at least 10 or more electrodes and a layer of solid electrolyte is disposed between every two layers of electrode material.

17. The energy storage device of claim 12, further comprising a heating device to elevate the temperature of the capacitor during charging.

18. The solid-state capacitor of claim 12, further comprising a heating device to elevate the temperature of the capacitor during charging.

19. The solid-state capacitor of claim 12, wherein the yttria content of the solid electrolyte is at least 8%.

20. The solid state capacitor of claim 12, wherein the capacitor has a measurable capacitance based on a combination of electrostatic and faradaic capacitance.
